(19) United States
(12) Patent Application Publication
(10) Pub. No.: US 2026/0035121 A1
(43) Pub. Date: Feb. 5, 2026

(54) METHOD FOR DISCHARGING A CONTAINER FROM A BAG, CUTTING DEVICE, REMOVAL DEVICE AND UNPACKING DEVICE

(71) Applicant: TT Innovation AG, Zug (CH)

(72) Inventors: Marc Tondera, Riehen (DE); Christian FROMMHERZ, Rheinfelden (DE); Alexandre ISOZ, Allschwil (CH); Tobias Jan SCHNEIDLER, Diepflingen (CH); Mathieu MÜLLER, Sierentz (FR); Mike ZELLER, Wahlen (CH)

(73) Assignee: TT Innovation AG, Zug (CH)

(21) Appl. No.: 18/998,360

(22) PCT Filed: Jul. 13, 2023
(86) PCT No.: PCT/EP2023/069539

§ 371 Date: Jan. 24, 2025

(30) Foreign Application Priority Data
Jul. 26, 2022 (DE) 10 2022 118 701.2

(51) Int. Cl. B65B 69/00; B26D 1/22; B26D 7/26

(52) U.S. Cl. CPC B65B 69/0008; B26D 1/225; B26D 7/2621

(57) ABSTRACT

The invention generally proposes a method, a cutting device (1), a removal device (20) and an unpacking device (26) for preferably mechanically discharging a container (3) from a bag (2), wherein the bag (2) is cut open with at least one cut (13) and the container (3) is discharged via an opening (14) formed by the cut (13), wherein, in order to cut the bag (2), a disk-shaped knife blade (5) interacts with a counter element (6), in particular rolls on the counter element (6) (FIG. 2).

### CROSS-REFERENCE TO RELATED APPLICATIONS

This application is a 371 National Phase of PCT/EP2023/069539, filed Jul. 13, 2023, which claims priority from German Patent Application No. 10 2022 118 701.2, filed Jul. 26, 2022, both of which are incorporated herein by reference as if fully set forth.

### TECHNICAL FIELD

The invention relates to a method for discharging, preferably for mechanically discharging, a container from a bag, wherein the bag is cut open with at least one cut and the container is discharged via an opening formed by the cut.

The invention furthermore relates to a cutting device for a bag containing a container, having a knife for cutting the bag.

The invention furthermore relates to a removal device for removing a container from a bag containing the container.

The invention furthermore relates to an unpacking device.

### BACKGROUND

Protected rooms, for example clean rooms, such as isolators or restricted access barrier systems (RABS), are used in industry to manufacture, for example, pharmaceutical products in a sterile or germ-free way. To manufacture pharmaceutical products, product components, such as containers, have to be transferred in a sterile or germ-free way to the section of a protected room where the product components are processed for manufacturing.

Prior to their use, containers are usually packaged in a sterile way in bags. The containers located in the bags have to be removed from the bags in order to complete a product. It is known from the prior art that, for the opening, bags are placed into devices and gripped. The bags are then cut below the region at which the bag is gripped. A disadvantage of this is that the opening formed by the cut is not closed or sealed, and therefore there is the risk of cutting waste or other contaminations being able to pass into the interior of the upright bag and contaminate the container.

In addition, bags can be placed onto a support and opened by punching or cutting. The end surfaces of the bags are usually spread flat manually by a worker, which is time-consuming and leads to an increased risk of contaminations. The worker is also exposed to an increased risk of injury because of being in the vicinity of the punching and/or cutting device.

In order to cut the bag, use is usually made of knives, the knife blades of which are ground on one side. Use is thus frequently made of knife blades in the manner of razor blades. A disadvantage of this is that the knife blades from the prior art have to be frequently replaced, which results in the relatively high probability of a worker being injured. Furthermore, the cut edge of such knife blades is often shorter than the section to be cut on the bag, and therefore the knife blades have to be particularly frequently replaced due to wear.

It is known that a cut bag can be held at its top side and/or underside by a holding means and that the bag opening formed by the cut is further opened, in particular by the holding means, such that the container is discharged from the bag by the action of at least one conveying means. In the prior art, it is a disadvantage that the bag is held between the opening formed by the cut and the container, as a result of which a prior adjustment of the container within the bag is necessary, which may additionally slow down the process.

### SUMMARY

The disadvantages known from the prior art mean that it is the object of the invention to improve the discharging of a container from a bag. In particular, the intention is to improve the cutting of the bag and/or the discharging of the container from the bag.

In order to achieve the stated object, according to the invention one or more of the features disclosed herein are provided. In particular, in order to achieve the stated object in a method of the type described at the beginning, it is thus proposed according to the invention that, in order to cut the bag, a disk-shaped knife blade interacts with a counter element, in particular rolls on the counter element. The knife blade can preferably be guided by the counter element and/or the knife blade and the counter element can mutually exert pressure on each other. Such interaction between the knife blade and the counter element enables the bag to be cut particularly accurately and neatly.

The rolling of the knife blade on the counter element makes it possible for little force to be expended on the cutting and for at least a large part of the disk-shaped knife blade to be used for opening the bag. The knife blade can preferably be round or oval, with the cut edge of the knife blade preferably extending over the entire circumference of the disk-shaped knife blade. In particular with such a knife blade, the method according to the invention can be implemented particularly efficiently and so as to save on resources, since the knife blade is less severely stressed. Thus, it is not necessary to replace the knife blade frequently, as a result of which in particular workers can be protected from injury. It has been found that, with a rolling knife blade, a cutting section automatically changes during the cutting operation, while, with a rigid knife blade, the same section always carries out the cutting. It can thus be achieved that the rolling knife blade becomes blunt less quickly and needs to be replaced less frequently. It is further advantageous that, during the cutting operation, a shearing stress on the material to be cut can be reduced. More precise cuts can therefore be made, and wear on the knife blade can be reduced.

It may also be advantageous that, with the method according to the invention, fewer contaminations occur during the cutting operation, as a result of which the container located in the bag is contaminated less severely to not at all. Overall, a method for discharging a container, in particular in sterile rooms, can thus be improved.

In an advantageous refinement of the method, it can be provided that the knife blade and/or the counter element are/is driven by motor. Motor-driven knife blades and/or counter elements are particularly advantageous if manual work, for example in protected rooms, is intended to be avoided. Workers can therefore also be advantageously protected from cutting injuries. Furthermore, a cut can be carried out even more neatly by a motor-driven knife blade and/or by a motor-driven counter element, and therefore even less abrasion and/or contaminations can be produced at the opening formed by the cut. Thus, a container can advantageously be discharged from the bag particularly free from contamination. The knife blade can be arranged here freely rotating, for example on a slide movable by motor. Thus, the knife blade can roll on a counter element, which can itself be arranged, for example, to be stationary or rotating. This has the advantage that different regions of the knife blade come into engagement during the cutting, and therefore the knife blade becomes blunt less quickly.

Alternatively or in addition, it can be provided that the knife blade and/or the counter element are/is mechanically coupled to an actuator that can be manually actuated from the outside. Thus, a method can also be carried out by an actuator that can be manually actuated. It is thus advantageously possible that a cutting operation can be controlled from the outside by a worker such that both a protected room and the worker can be protected.

For example, a protected room can be characterizable in that a passage of a (for example, liquid or gaseous) substance, an object, an interaction (e.g. electromagnetic and/or radioactive and/or high-energy radiation) and/or a person is controllable, in particular preventable, by a boundary of the room, for example from the inside and/or from the outside.

In an advantageous refinement of the method, it can be provided that the counter element is a roller. Thus, cutting operation can advantageously produce particularly little abrasion since both the disk-shaped knife blade and the counter element can carry out a rotational movement during which the bag is cut. This allows the knife blade to stay sharp for longer. Another advantage of the rolling is that different regions or sections of the knife blade intersect during the cutting operation, and therefore the wear can be evenly distributed over the entire knife blade.

Alternatively or additionally, it can be provided that the counter element is a rectilinear running surface. Thus, the knife blade can advantageously be guided on the running surface, as a result of which a cut can also take place in a targeted region of the bag.

Alternatively or in addition, it can also be provided that the counter element is a scissor blade. Thus, the bag can be cut from two sides, i.e. by the knife blade and the scissor blade. Two-sided cutting can ensure that the cut can be carried out even more neatly. This can also ensure that, if the knife blade is blunt or partly blunted, a bag can still be cut.

In an advantageous refinement of the method, it can be provided that the bag is gripped by a gripping mechanism, on which a knife is moved for cutting the bag. Thus, the bag can be advantageously held by the gripping mechanism during the cutting operation. Since a knife for cutting the bag is moved on the gripping mechanism, space and material can be saved, since the holding and cutting of the bag can therefore be carried out by or on the gripping mechanism.

In an advantageous refinement of the method, it can be provided that the bag is held below the cut, in particular that the opening remains closed, in particular for microorganisms and/or particles, after the cut has been made. By the bag being held below the cut, it is ensured that the bag does not drop down after the cutting operation. Closing the opening after the cut has been made can prevent cutting waste and/or other contaminations from passing into the interior of the bag.

In an advantageous refinement of the method, it can be provided that the bag hangs on a bag carrier while the cut is being made. The bag carrier can be attached to a gripping mechanism, in particular a gripping mechanism as described above or claimed below, such that the bag can be advantageously gripped, held and opened by a device. A bag hanging on a bag carrier no longer needs to be correctly positioned before the cutting operation, in particular if, as described above or claimed below, the bag is held below the cut. This allows particularly effective cutting of the bag and discharging of the bag.

In an advantageous refinement of the method, it can be provided that a knife slide is magnetically coupled to a drive device and is moved by the latter. Thus, a knife slide, that is, a movable component which has at least one knife, can be magnetically coupled to a drive device and moved by the latter. Owing to the magnetic coupling, the knife slide can be moved virtually frictionlessly, and therefore particularly little or no abrasion at all arises during the movement of the knife slide. This is particularly advantageous if the method is carried out in a protected room.

Alternatively or additionally, the knife slide can be used in order to be moved on a gripping mechanism, in particular the aforementioned gripping mechanism. This means that a container can be discharged even more efficiently from a bag.

In an advantageous refinement of the method, it can be provided that the bag is held level with the container by at least one releasable holding means while a conveying means slides the container out of the bag. This means that the container can be easily slid out of the bag without the bag being displaced. Once the container has been discharged, the holding means can be detached from the empty bag so that the bag can be disposed of.

The releasable holding means can be designed in particular as a suction gripper, as a result of which the detaching of the holding means from the bag can be carried out relatively easily, especially after the container has been discharged.

In an advantageous refinement of the method, it can be provided that the holding means lift a top side of the bag during the sliding operation. Thus, the container can be slid out of the bag without touching an inner wall of the bag and/or the cut edge at the opening of the bag. Contamination of the container at the opening, in particular during the discharging operation, can therefore be prevented.

In an advantageous refinement of the method, it can be provided that the underside of the bag lies unfixed on a support during the sliding operation. Unfixed should be understood as meaning in particular that the bag lies in an at least partially freely movable manner on the support. The bag can also lie in a completely freely movable manner on the support. The unfixed resting of the bag on the support means that the sliding of the container out of the bag can be carried out easily, in particular if the bag is held on a top side by a holding means, in particular the aforementioned holding means.

In an advantageous refinement of the method, it can be provided that the bag is blown against, preferably from the front, before and/or during the sliding operation. The bag can be blown against with preferably filtered air and/or another preferably filtered gas, preferably from an adjacent chamber. The volume within the bag can therefore be increased, as a result of which a distance of the container in particular from a top side of the bag can be increased. This allows the container to be protected even better from contaminations, in particular at the opening formed by the cut, during the discharging operation. The blowing against the bag can be brought about, for example, with a lance, which is guided through the opening into the interior, and/or outside the bag in front of the opening. For example, this can be done through an access opening in an isolator or RABS arranged downstream in a processing path.

This method is all the more advantageous if, as described above or claimed below, the bag is held on its top side with a releasable holding means, in particular the aforementioned suction gripper.

In an advantageous refinement of the method, it can be provided that the conveying means stops before the container leaves the bag, i.e., before said container is, for example, completely outside the bag. Thus, it can advantageously be prevented that the container leaves the bag at an undesirable time. It can be provided, for example, that the container is received for further processing by a transport unit, in particular as described herein or claimed below. By stopping the conveying means and the associated stopping of the container, the transfer of the container to the aforementioned transport device can be synchronized. In addition, stopping the conveying means makes it possible to prevent the conveying means from passing through a portal in a wall, i.e., for example, breaching an area between two protected rooms. It can thus be ensured that no contaminations located, for example, on the conveying means, are transferred to the transport unit.

In an advantageous refinement of the method, it can be provided that the conveying means slides the container onto a container receptacle of a transport unit. The container can therefore be transported further directly from the bag.

In particular, it can be provided that the conveying means slides said container at least until a center of gravity of the container lies above the container receptacle. This allows the container to be optimally slid onto the container receptacle of the transport unit without the need for another device that pulls the container onto the container receptacle, for example.

In an advantageous refinement of the method, it can be provided that the transport unit is magnetically coupled to a stationary coil arrangement. It is thus advantageously possible that the transport unit can move magnetically in a room, as a result of which in particular abrasion during the discharging and transfer of the container out of the bag into the container receptacle can be reduced.

Alternatively or in addition, it can be provided that the transport unit is moved suspended in an electromagnetic field. This means that abrasion can be prevented to an even greater extent.

In an alternative refinement of the method, it can be provided that preferably pivotable centering means align the container in the bag before the Sliding transversely to a sliding direction preferably onto the or a container receptacle. By means of the preferably pivotable centering means, the container can be aligned before the sliding. This makes it possible to ensure that the container, on exiting from the opening in the bag, is correctly slid onto the container receptacle. Thus, the transfer of the container to a transport unit, in particular the transport unit already mentioned, can be optimally carried out.

In an advantageous refinement of the method, it can be provided that an emptied bag is pushed through a disposal opening in a support for filled bags. Thus, after the container has emerged from the opening, the bag can be disposed of directly, for example in a closable opening at or on the support. By directly disposing of the emptied bag, another filled bag can be placed directly onto the support and the container located therein can be discharged. This enables a plurality of bags to be processed in a relatively short period of time, which can reduce an overall process time.

In an advantageous refinement of the method, it can be provided that, for the sliding operation, the conveying means acts on the underside of the bag from the outside with at least one roller that slides the container out of the bag. Thus, a rotational movement of the at least one roller can be used to act upon the container from the underside of the bag and to slide said container out of the bag. The invention has recognized that this refinement is particularly effective, since, for example, unevennesses in the supported bag can be prevented or eliminated, as a result of which the container can be easily driven out of the bag.

Alternatively or in addition, for the sliding operation, the conveying means can act on the top side of the bag from the outside with at least one sliding block that slides the container out of the bag. This means that a container can be slid particularly efficiently out of the bag.

In an advantageous refinement of the method, it can be provided that the bag which has been cut open is kept closed until the holding means engages thereon. For example, the bag which has been cut open can be kept closed by a gripping mechanism, in particular the gripping mechanism already mentioned. This reduces the time in which contaminations can enter through the opening formed by the cut.

In an advantageous refinement of the method, it can be provided that, at least during the sliding of the container, a fluid flow directed against the inserted bag is generated. The fluid flow can advantageously prevent contaminations, for example contaminations located on an outside of the bag, from passing into downstream sections during the sliding operation. It is thus possible to prevent, for example, that as a container is being driven out onto a transport unit, an, in particular the aforementioned, contamination passes onto the transport unit. Increased process safety and/or product safety can thus be ensured.

A preferred application of the described and/or disclosed method is in a protected room and/or with a bag having sterile contents.

A protected room can be characterized, for example, as a region with a boundary, wherein an exchange of substances beyond the boundary is controllable, in particular preventable. Thus, defined environmental conditions within the boundary can be established and/or undesirable or hazardous discharges of substances can be prevented. The invention makes it possible here to very substantially automatically discharge sterile bag contents, for example, the described container, from the bag, so that the need for human intervention can be reduced. Examples of a protected room include an isolator or a restricted access barrier system (RABS).

Alternatively or additionally, in order to achieve the stated object, one or more of the features disclosed herein directed to a cutting device, are provided according to the invention. In particular, in order to achieve the stated object in a cutting device of the type described at the beginning, it is thus proposed according to the invention that a knife blade is disk-shaped and interacts on a counter element, in particular rolls on the counter element. Such a cutting device can be used in particular for carrying out a method described previously and/or claimed below.

A knife blade, which is disk-shaped, can be advantageous in that the knife blade wears out more slowly. The cut edge of the preferably round or oval knife blade can be larger than the cutting area of the bag to be cut. In particular if the knife blade of the cutting device according to the invention rolls on the counter element, i.e., if the knife blade carries out preferably a rotational movement, the wear on the knife blade can be particularly greatly reduced. This can eliminate the need to change the knife blade frequently, thus reducing human intervention, in particular in a protected room. The wear is also very even, which allows a greater change interval (for example, a straight blade always has the same wear point).

In an advantageous refinement, it can be provided that the counter element is a roller. Thus, cutting operation can advantageously produce particularly little abrasion since both the disk-shaped knife blade and the counter element can carry out a rotational movement during which the bag is cut. This allows the knife blade to stay sharp for longer.

Alternatively or additionally, it can be provided that the counter element is a rectilinear running surface. Thus, the knife blade can advantageously be guided on the running surface, as a result of which a cut can also take place in a targeted region of the bag.

Alternatively or in addition, it can also be provided that the counter element is a scissor blade. Thus, the bag can be cut from two sides, i.e. by the knife blade and the scissor blade. Two-sided cutting can ensure that the cut can be carried out even more neatly. This can also ensure that, if the knife blade is blunt or partly blunted, a bag can still be cut.

In an advantageous refinement, it can be provided that the knife blade is coupled to a drive roller, which is designed for rolling on part of the bag. This allows the knife blade advantageously to carry out a rotational movement. Thus, the entire circumference of the disk-shaped knife blade can be used to cut a bag.

In an advantageous refinement, it can be provided that the knife is arranged so as to be movable to a gripping mechanism for the bags. Thus, the bag can be advantageously gripped by the gripping mechanism and cut or opened by the movable knife.

The gripping mechanism has formed at least one gripping finger, on which the knife can be arranged so as to be movable. Preferably, the length of the gripping finger is at least as long as a width of a bag. This allows the bag to be gripped and completely cut or opened on the gripping side.

Preferably, the gripping mechanism has formed at least two gripping fingers, wherein the knife, as previously described, is arranged on the first gripping finger so as to be movable, and wherein the counter element can be arranged on the second gripping finger. By means of such a gripping device, cutting of a bag can be particularly improved.

It can also be provided that the gripping mechanism has additionally formed at least one scissor blade. In this case, the scissor blade(s) can be formed on the first and/or the second gripping finger. In particular, the scissor blade(s) can be designed as a counter element.

In an advantageous refinement, it can be provided that the counter element is formed on a gripping finger of the gripping mechanism with which the bag can be held below the cut. Thus, advantageously, the knife blade and the counter element can be guided close to each other by the gripping mechanism, in particular if, as described herein and/or claimed below, the knife is arranged so as to be movable to the gripping mechanism for the bags. Thus, advantageously, the bag can be gripped, held and cut by the gripping mechanism.

In an advantageous refinement, it can be provided that the knife is formed on a gripping finger of a gripping mechanism with which the bag can be held below the cut, in particular so that the opening remains closed after the cut has been made. Thus, advantageously, the knife blade and the counter element can be guided close to each other by the gripping device, in particular if, as previously mentioned and/or claimed below, the counter element is arranged on a gripping finger of the gripping mechanism. This can save space and costs in that the gripping and cutting can be carried out in one place and by a device, in particular the aforementioned gripping mechanism.

In particular, the opening can remain closed after the cut has been made. This can prevent contaminations from entering the inside of the bag during the cutting operation and/or after the cut has been made.

In an advantageous refinement, it can be provided that the knife is magnetically coupled to a preferably encapsulated drive device. For example, the drive device can be located on and/or in a gripping finger of the aforementioned gripping mechanism. Magnetic coupling allows the knife to move in a suspended manner, resulting in less abrasion. Owing to the reduced abrasion, in addition to the inside of the bag, a protected room can also be contaminated to a lesser extent or not at all. The encapsulation of the drive device can be formed at least partially by the gripping mechanism, in particular by a gripping finger. This can protect the drive device from abrasion and other factors.

In an advantageous refinement, it can be provided that the drive device has a movable permanent magnet. Thus, the knife can be coupled in a permanently suspended manner to the drive device and moved in a suspended manner. This means that abrasion can be reduced even if the knife is moved to a maintenance or holding position.

In an advantageous refinement, it can be provided that the knife is arranged on a carriage, which has a preferably magnetic counter-coupling means. This counter-coupling element is preferably designed as a permanent magnet. By this means, a permanent coupling between carriage/knife and drive device can be formed.

In particular, it can be provided that the knife is removable from the carriage. This makes it easier to replace or service the knife or the knife blade.

Preferably, the knife is in an enclosure. This means that the knife can be protected during operation by the enclosure as can a worker wanting to remove and service/change the knife or the knife blade.

Alternatively or additionally, in order to achieve the stated object, according to the invention one or more of the features directed to a removal device, are provided. In particular, in order to achieve the stated object in a removal device of the type described at the beginning, it is thus proposed according to the invention that the unpacking device has a holding means, in particular a suction gripper, with which the inserted bag can be held by its top side level with the container, and/or at least one roller which can act on the underside of the inserted bag, wherein the at least one roller is movable along the underside of the bag. The holding means, in particular the holding means described herein, can hold the top side of the bag such that the top side can be lifted off from the underside of the bag, as a result of which the container can be more easily discharged from the bag. In the case of the removal device according to the invention, it is provided that the bag can be held level with the container. Thus, the holding means can advantageously contact and hold the bag level with the container, as a result of which a prior adjustment of the container within the bag, as known from the prior art, is no longer necessary.

The invention has recognized that the roller, which can act upon the underside of the inserted bag, enables the container to be removed particularly effectively from the bag. Preferably, the roller is designed as described above or claimed below.

In an advantageous refinement, it can be provided that a counter-flow device is designed for generating a fluid flow directed against the inserted bag. The counter-flow device can be positioned in the abovementioned room or in a protected room. The counter-flow device allows the inserted bag to be inflated with fluid flow, which can improve the discharging of the container, since the container, as it is being discharged, does not touch the top side and/or the opening in the bag. The fluid flow can also help protect the container from contamination from the environment.

The inflating can be achievable, for example, by a flow passing over the bag. This has the advantage, for example, compared to inflating with a lance inserted into the bag, that no unnecessary parts have to be inserted into the bag.

Alternatively or additionally, in order to achieve the stated object, according to the invention one or more of the features directed to an unpacking device, are provided. In particular, in order to achieve the stated object in the case of an unpacking device of the type described at the beginning, it is thus proposed according to the invention that the unpacking device has means for carrying out a method as described above or claimed below, and/or a cutting device as described above or claimed below, and/or a as described above or claimed below, in particular within a protected room. Thus, a bag can be cut and discharged in particular in a protected room. This is particularly advantageous in the pharmaceutical industry, but also in other branches of industry in which work is carried out preferably in a sterile or germ-free way.

### BRIEF DESCRIPTION OF THE DRAWINGS

The invention will now be described in more detail on the basis of exemplary embodiments, but is not restricted to these exemplary embodiments. Further exemplary embodiments arise from combining the features of individual or multiple claims with one another and/or with individual or multiple features of the exemplary embodiments.

In the Figures:

FIG. 1 shows a cutting device according to the invention and a bag,

FIG. 2 shows the cutting device according to the invention from FIG. 1, which grips the bag,

FIG. 3 shows a knife slide on a gripping mechanism,

FIG. 4 shows the knife slide from FIG. 3 in cross section,

FIG. 5 shows a carriage with permanent magnets,

FIG. 6 shows a round, disk-shaped knife blade,

FIG. 7 shows a removal device according to the invention,

FIG. 8 shows an alternative embodiment of a removal device according to the invention,

FIG. 9 shows the removal device from FIG. 8 during the discharging of a container,

FIG. 10 shows the removal device from FIG. 8 after the disposal of an emptied bag,

FIG. 11 to FIG. 14 show a method for emptying a bag with a removal device according to the invention,

FIG. 15 shows a container being transferred from a removal device according to the invention to a transport unit coupled to a stationary coil arrangement, and

FIG. 16 shows a schematic illustration of another cutting device in an illustration from the side (on the left), from the front (center) and obliquely from above (on the right).

### DETAILED DESCRIPTION

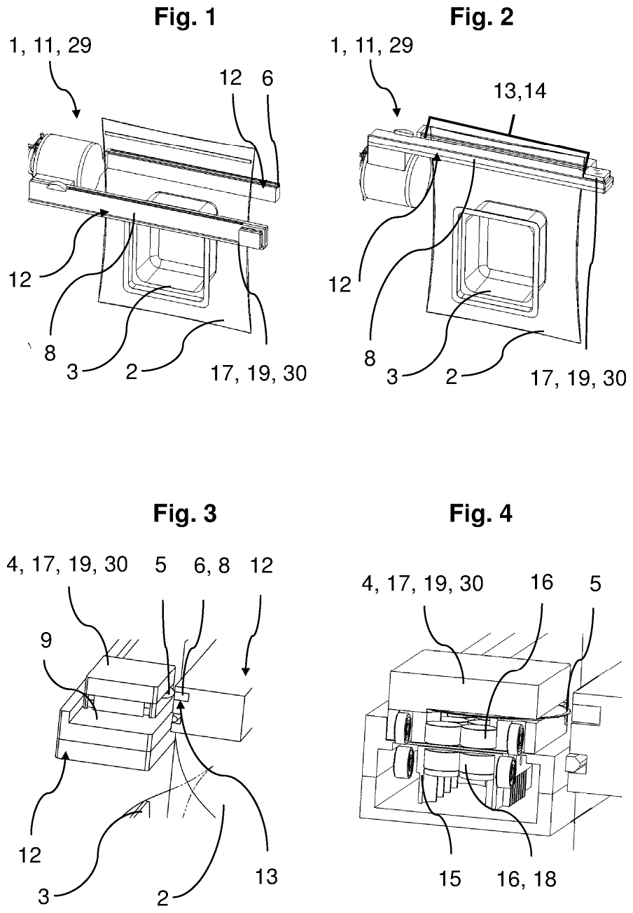

FIGS. 1 and 2 show a cutting device 1 according to the invention designed as a gripping mechanism 11.

It can also be seen from FIGS. 1 and 2 that a bag 2 positioned on the gripping mechanism 11 and filled with a container 3 can be gripped by the gripping mechanism 11 (see FIG. 2). In this case, the bag 2 is held by the gripping mechanism 11 below the cut 13 or below the opening 14 formed by the cut. For better understanding, the cut 13 (i.e., in particular, the cutting path of the knife blade 5 of the knife slide 30 shown in FIGS. 3 and 4) and the opening 14 are schematically illustrated, although the bag 2 has not yet been cut in FIGS. 1 and 2. By means of the cutting device 1, 11 shown in FIGS. 1 and 2, the bag 2 can be and is held below the cut 13, so that the opening 14 in the bag 2 remains closed after the cut 13 has been made. While the cut 13 (not shown) is being made, the bag 2 hangs on the cutting device 1, 11, which is designed as a bag carrier 29, as a result of which the container 3 advantageously moves away from the opening 14. By means of the embodiment of the cutting device 1, 11, 29 shown in FIGS. 1 and 2, it is advantageously ensured that the inside of the bag 2, in particular the container 3, is not contaminated with abrasion or other contaminations during and/or after the cutting operation.

Furthermore, it is advantageous, in the embodiment according to FIGS. 1 and 2, that the cutting device 1, the gripping mechanism 11 and the bag carrier 29 are realized in one device 1, 11, 29. This can save a great deal of space, which is especially useful in protected rooms 27. Alternatively or additionally, the cutting device 1, gripping mechanism 11 and bag carrier 29 may be separate devices (not shown). It can also be provided that two of the three devices mentioned are formed in one embodiment. For example, the cutting device 1 and bag carrier 29 may be designed as one device 1, 29 (not shown).

The gripping mechanism 11 has two gripping fingers 12. A knife slide 30 is arranged so as to be movable on a first gripping finger 12 of the gripping mechanism 11 (see FIGS. 3 and 4). The knife 4 has a round, disk-shaped knife blade 5. Alternatively, the disk-shaped knife blade 5 may be oval. The cut edge of the knife blade 5 extends over the entire circumference of the disk-shaped knife blade 5, as shown in FIG. 6. Thus, a bag 2 can be particularly efficiently cut and opened, with the knife blade 5 being less severely stressed. This means that it is not necessary to replace the knife blade frequently.

FIG. 6 shows, by way of example, in the upper half of the image, a variant in which a drive roller 10 for rolling on the bag 2 is arranged. The knife blade 5 cuts the bag 2 against the drive roller 10.

FIG. 16 shows this variant in more detail from different viewing angles. It can be seen that the running surface 7 is significantly wider than the knife blade 5.

The drive roller 10 can be rotated here by a drive, not illustrated specifically, in order to convey a bag 2 past the knife blade 5.

It is also possible to realize a passive cutting device 1 by pulling the drive roller 10 together with the knife blade 5 in order to roll on the bag 2 and cut the latter.

On the other hand, in a preferred refinement according to the lower half of the image in FIG. 6, only the knife blade 5 is pulled (indicated by the arrow Pf), so that it rolls on the bag 2 and cuts against a static support, here by way of example the gripping finger 12.

It can be seen in particular in FIGS. 3 and 4 that the knife blade 5 can be rolled on the counter element 6 positioned on the second gripping finger 12 of the gripping mechanism 11. The counter element 6 of the embodiment shown in FIGS. 1 to 4 is designed as a rectilinear running surface 7. Alternatively or additionally, the counter element 6 can be designed as a roller and/or as a scissor blade, as a result of which the counter element 6 can be advantageously adapted to the configuration of the knife 4 or to the embodiment of the knife blade 5 in order to achieve an optimal interaction with, or cutting of, a bag 2.

As can be seen in FIG. 4, the knife slide 30 is magnetically coupled to an encapsulated drive device 15 and is movable by the latter on a drive surface 9. The encapsulation 8 of the drive device 15 can be formed at least partially by the gripping mechanism 11, in particular by a gripping finger 12. This enables the drive device 15 to be protected from abrasion and other factors.

The knife slide 30 is designed as a carriage 17, which has an enclosure 19 surrounding at least the knife 5. The enclosure 19 is formed removably on the carriage 17, so that the knife 5 can be exchanged or replaced. The enclosure 19 protects the knife 4 during operation, and a worker during maintenance.

The abovementioned magnetic coupling is carried out via a counter-coupling means 18 of the knife slide 30, which is designed as a permanent magnet 16. The counter-coupling element 16, 18 is magnetically coupled to a permanent magnet 16 of the drive device 15.

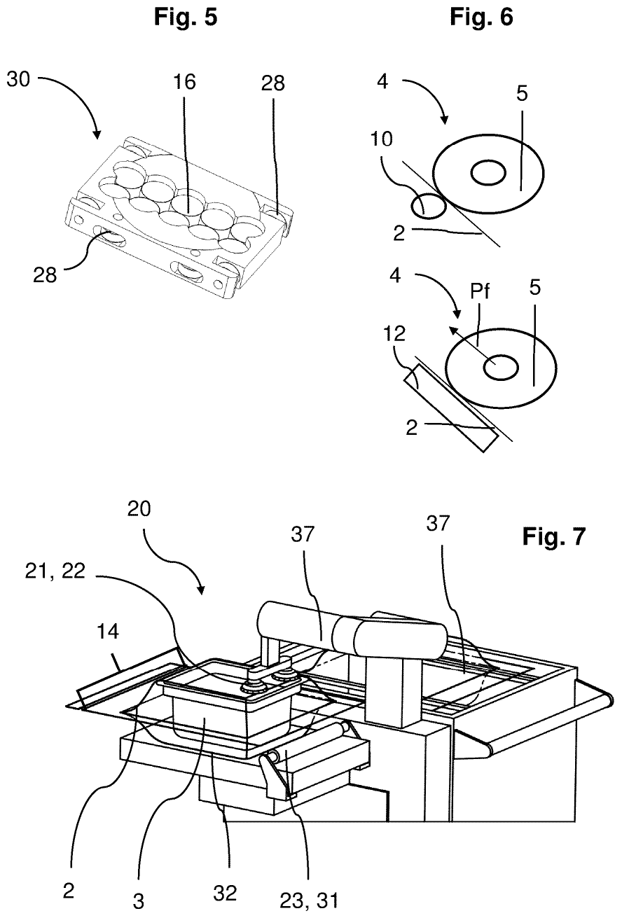

It can be seen in FIG. 5 that the knife slide 30 has, in addition to the counter-coupling means 16, 18, six wheels 28, by which the knife slide 30 can advantageously move on a drive surface, in particular the abovementioned drive surface 9, or can be aligned with a gripping finger, in particular the abovementioned gripping finger 12. Alternatively, the knife slide 30 may also have fewer or more than six wheels 28 or no wheels 28 at all.

The drive surface 9 of the first gripping finger 12 of the gripping mechanism 11 is designed to be magnetically neutral, i.e., at least in such a way that the magnetic coupling between the counter-coupling element 16, 18 and the drive device 15 is not disturbed. Thus, advantageously, an at least virtually abrasion-free movement of the knife slide 30 can be made possible, as is also the case with the cutting device 1, 11, 29 in FIGS. 1 to 4.

The knife blade 5 of the knife 4 of the cutting device 1, 11, 29 is coupled to a drive roller 10, which is designed for rolling on part of the bag 2 (see FIG. 6).

FIGS. 7 to 15 show exemplary embodiments according to the invention of removal device 20. Components and functional units which are similar or identical functionally and/or structurally to the preceding exemplary embodiments are denoted by the same reference signs and not separately described again. The statements made relating to FIGS. 1 to 6 therefore correspondingly apply to FIGS. 7 to 15.

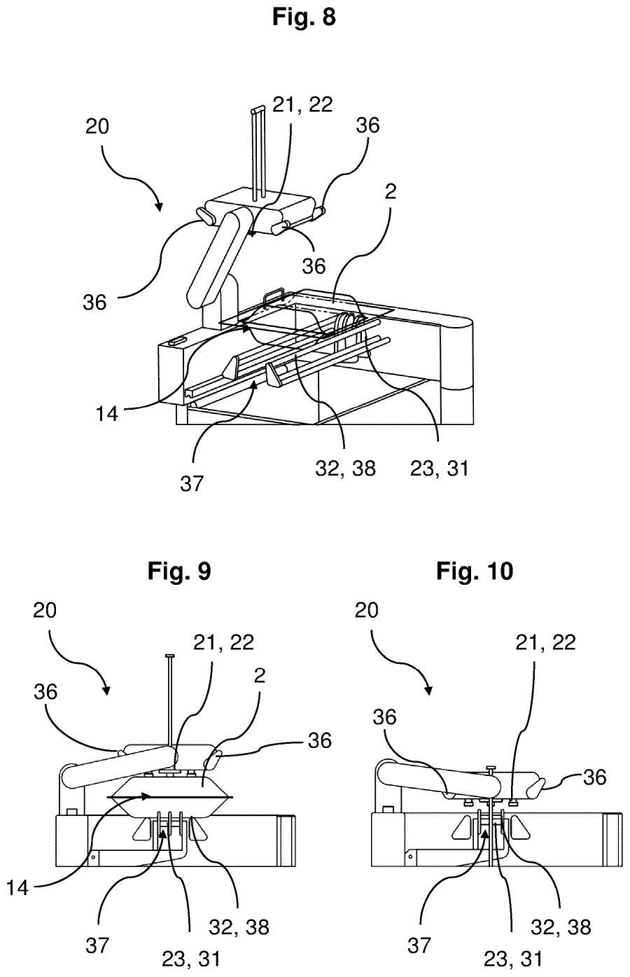

The embodiment in FIG. 7 and the embodiment of an unpacking device 20 shown in FIGS. 8 to 10 differ at least by the disposal of emptied bags 2. In the embodiment according to FIG. 7, it is provided that an emptied bag 2 is pushed through a disposal opening 37 outside a support 38 for filled bags 2. Between the disposal opening 37 and the support 38, a movable holding means 21 designed as a suction gripper 22 is provided. The holding means 21, 22 are used to move the emptied bag 2 from the support 38 to the disposal opening 37 and release the bag therein (not shown). In this embodiment, the support 38 and disposal opening 37 may be formed separately from each other, as a result of which in particular the support 38 can be variably configured.

In the embodiment according to FIGS. 8 to 10, it is provided that the emptied bag 2 is pushed through a disposal opening 37 in a support 38 for filled bags 2. Such a removal device 20 can save space, which in particular optimizes working in protected rooms 27.

An identical feature of the embodiments of FIG. 7 and the embodiment shown in FIGS. 8 to 10 is that the bag 2 is held level with the container 3 by the releasable holding means 21, 22, while a conveying means 31 designed as at least one roller 23 slides or can slide the container 3 out of the bag 2.

In the following, a method according to the invention for the preferably mechanical discharging of a container 3 from a bag 2 is described, which may proceed as follows:

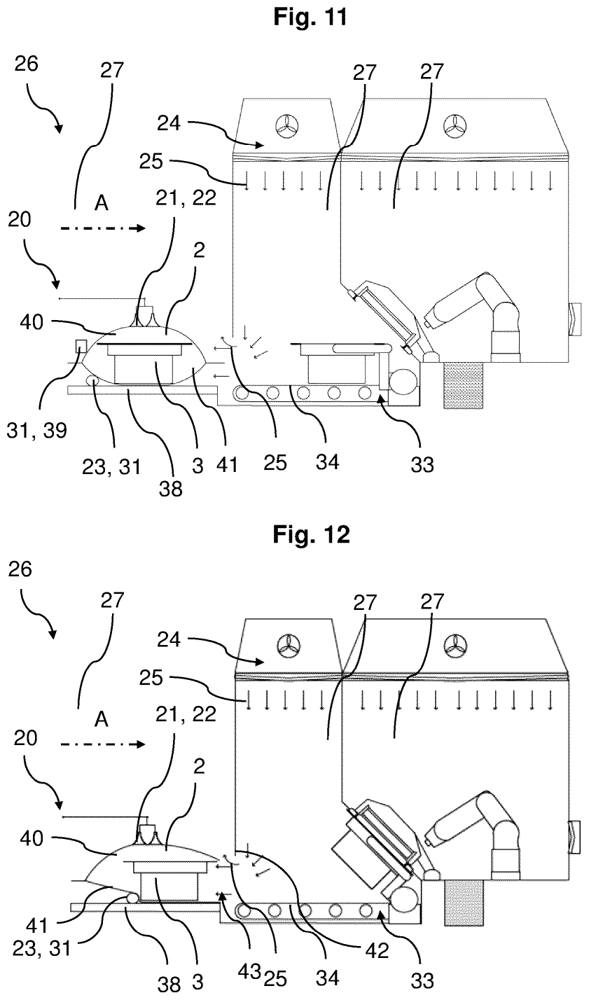

The method according to the invention takes place within a protected room 27 designed as an isolator or RABS (see FIGS. 11 to 15). The unpacking device 26 of FIGS. 11 to 15 has means for carrying out the method and has a cutting device 1, preferably as shown in FIGS. 1 to 4, and a removal device 30, preferably as shown in FIG. 7 or in FIGS. 8 to 10.

The bag 2 filled with a container 3 is gripped from a store (not shown) by the cutting device 1, 11, 29 (see FIGS. 1 and 2). The bag 2 is held below the cut 13 (see FIG. 2) so that the opening 14 remains closed after the cut 13 has been made. In particular, it can be seen in FIGS. 8, 9 and 11 that the bag 2, which has been deposited on the support 38 of the removal device 20 and has already been cut, still has a closed opening 14.

The bag 2 is cut open with at least one cut 13, wherein, for cutting the bag 2, the disk-shaped knife blade 5 is moved on the drive surface 9 of the first gripping finger 12 (cf. FIG. 2). In the process, the knife blade 5 rolled on the counter element 6 located on the second gripping finger 12. The knife blade 5 and/or the counter element 6 can be driven by motor and/or mechanically coupled to an actuator, which can be actuated manually from the outside.

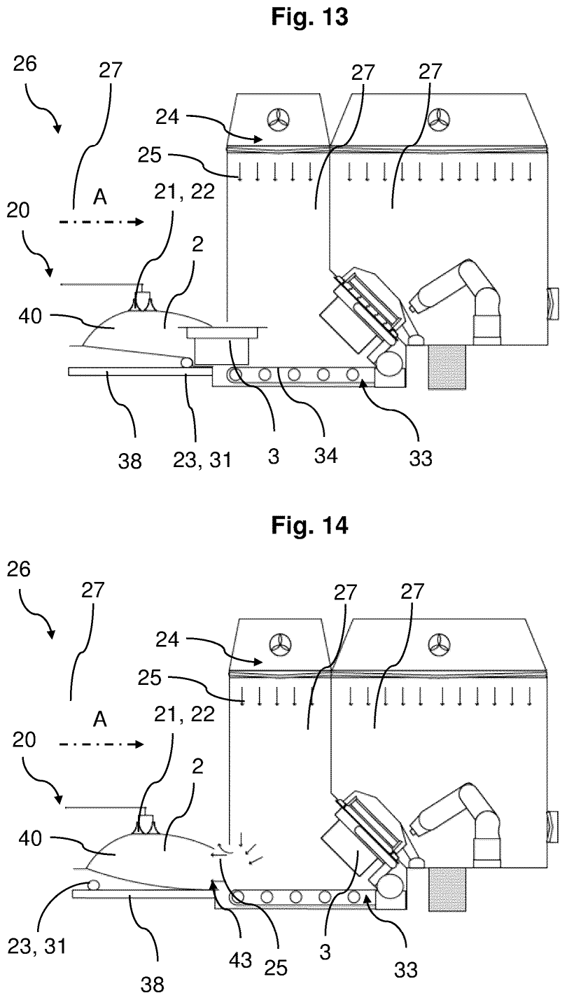

After the cut 13 has been made, the bag 2 is placed on the support 38 of the removal device 20, as shown in FIGS. 7, 8 and 11. The holding means 21, 22 of the removal device 20 are used to hold the bag 2 level with the container 3. The container 3 is aligned by preferably pivotable centering means 36, for example as shown in FIGS. 8 to 11, in the bag 2 before the sliding transversely to the sliding direction A onto a container receptacle 34 of a transport unit 33. Thus, the container 3 can be slid directly onto the transport unit 33 for further processing without falling from the latter (see FIGS. 13 and 14).

The container 3 is now slid out of the bag 2 by the conveying means 31 (see FIGS. 11 to 14). The conveying means 31 is preferably a roller 23 as shown in FIGS. 7 and 8. Alternatively or additionally, the conveying means 31 may also be designed as a sliding block 39, as is shown for illustrative purposes in FIG. 11.

For the sliding operation, the conveying means 31 acts on the underside 41 of the bag 2 from the outside with at least one roller 23, wherein the at least one roller 23 slides the container 3 outward. In the process, the bag 2 lies unfixed on the support 38 of the removal device 20.

Alternatively or additionally, the conveying means 31 can act on the top side 40 of the bag 2 from the outside with at least one sliding block, preferably the abovementioned sliding block 39, and can therefore slide the container 3 out of the bag 2.

During the sliding operation, the holding means 21, 22 lifts the top side 40 of the bag 2 (see FIGS. 12 to 14), thereby preventing the container 3, as it emerges, from touching the cut edge of the opening 14. Thus, the container 3 can be discharged in a sterile way from the bag 2. A sterile and improved discharging is further supported by the fact that the bag 2 is blown against from the front before and/or during the sliding operation. For this purpose, a counter-flow device 24 is used for generating a fluid flow 25 directed against the inserted bag 2 (see FIGS. 11 to 15). Furthermore, the fluid flow 25 can prevent the cut edge of the opening 14 from touching and contaminating a wall of the isolator or a portal 42 of the wall (see FIG. 12).

FIG. 13 shows that the conveying means 23, 31 stops before the container 3 leaves the bag 2. Furthermore, it can be seen that the conveying means 23, 31 slides the container 3 onto the container receptacle 34 of the aforementioned transport unit 33, wherein the conveying means 23, 31 slides said container until a center of gravity of the container 3 lies above the container receptacle 34. Thus, it is ensured that the conveying means 23, 31 does not pass through a portal 42, for example the aforementioned portal. Thus, it is advantageously prevented that any contaminations pass from a protected room 27 into a further protected room 27, in particular when, as described above or claimed below, during the sliding of the container 3, a fluid flow 25 directed against the inserted bag 2 and in particular its open discharge side 43 is generated (cf. FIG. 14).

In particular, the previously mentioned transport unit 33 can be used to further transport the discharged container 3 for further processing. The transport unit 33 can be any transport unit 33 known to a person skilled in the art. In FIGS. 11 to 14, the transport unit 33 is designed as a conveyor belt 32.

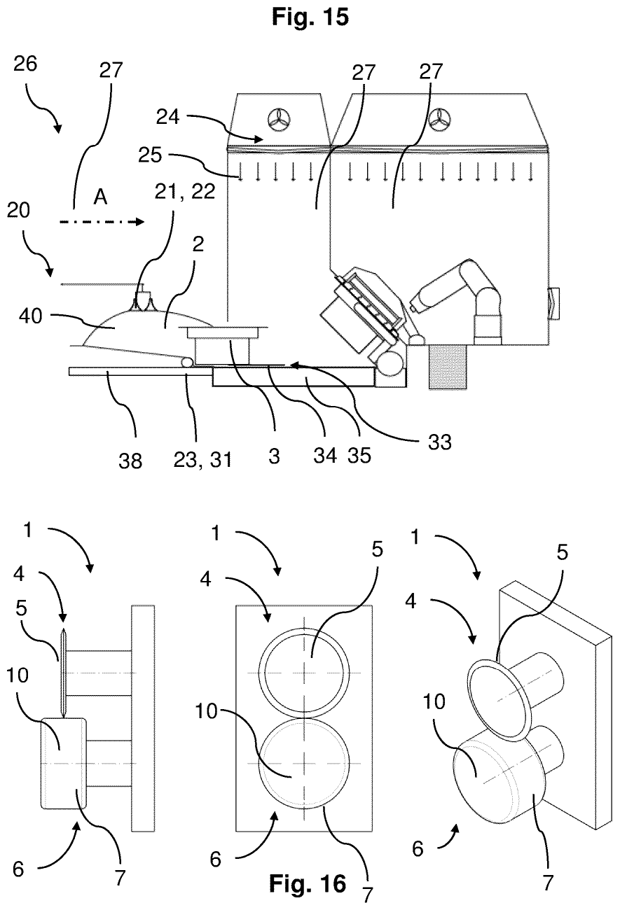

Preferably, it is provided that the transport unit 33 is magnetically coupled to a stationary coil arrangement 35 and is moved suspended in an electromagnetic field. This embodiment of a transport unit 33 is shown in FIG. 15. Thus, the container 3 can be received on the container receptacle 34 and further transported without abrasion.

After the container 3 has been driven out, the emptied bag 2 is pushed through a disposal opening 37, for example as shown and described above in the embodiments of FIG. 7 or FIGS. 8 to 10.

The invention generally proposes a method, a cutting device 1, a removal device 20 and an unpacking device 26 for preferably mechanically discharging a container 3 from a bag 2, wherein the bag 2 is cut open with at least one cut 13 and the container 3 is discharged via an opening 14 formed by the cut 13, wherein, in order to cut the bag 2, a disk-shaped knife blade 5 interacts with a counter element 6, in particular rolls on the counter element 6. Such an invention is used in particular in work taking place in protected clean rooms 27.

### LIST OF REFERENCE SIGNS

1 Cutting device
2 Bag
3 Container
4 Knife
Knife blade
6 Counter element
7 Running surface
8 Encapsulation
9 Drive surface
Drive roller
11 Gripping mechanism
12 Gripping finger
13 Cut
14 Opening of 2
Drive device
16 Permanent magnet
17 Carriage
18 Counter-coupling means
19 Enclosure
20 Removal device
21 Holding means
22 Suction gripper
23 Roller
24 Counter-flow device
25 Fluid flow
26 Unpacking device
27 Protected room
28 Wheels
29 Bag carrier
30 Knife slide
31 Conveying means
32 Conveyor belt
33 Transport unit
34 Container receptacle of 33
35 Stator arrangement
36 Centering means
37 Disposal opening
38 Support
39 Sliding block
40 Top side of 2
41 Underside of 2
42 Portal
43 Discharge side
A Sliding direction

1-31. (canceled)

32. A cutting device (1) for a bag (2) containing a container (3), the cutting device comprising:
a knife (4) for cutting the bag (2);
the knife (4) including a knife blade (5) that is disk-shaped;
a counter element (6) with which the knife blade (5) at least one of interacts or rolls on; and
an encapsulated drive device to which the knife (4) is magnetically coupled.

33. The cutting device (1) as claimed in claim 32, wherein the counter element (6) comprises at least one of a roller, a rectilinear running surface (7), or a scissor blade.

34. The cutting device (1) according to claim 32, further comprising the knife (4) being arranged so as to be movable on a gripping mechanism (11) for the bags (2).

35. The cutting device (1) as claimed in claim 34, wherein the counter element (6) is formed on a gripping finger (12) of the gripping mechanism (11) with which the bag (2) is adapted to be held below the cut (13).

36. The cutting device (1) as claimed in claim 34, wherein the knife (4) is formed on a gripping finger (12) of the gripping mechanism (11) with which the bag (2) is adapted to be held below the cut (13).

37. The cutting device (1) as claimed in claim 32, further comprising a carriage (17) on which the knife (4) is arranged, the carriage (17) including a counter-coupling means (18), such that the knife (4) is removable from the carriage (17).

38. A method for discharging a container (3) from a bag (2), the method comprising:
cutting open the bag (2) with at least one cut (13) to form an opening (14);
discharging the container (3) via the opening (14) formed by the cut (13);
the cutting open of the bag (2) including a disk-shaped knife blade (5) at least one of interacting with or rolling on a counter element (6);
gripping the bag (2) by a gripping mechanism (11), on which a knife (4) that includes the knife blade (5) is moved for cutting the bag (2);
hanging the bag (2) on a bag carrier (29) while the cut (13) is being made; and
wherein the knife (4) is magnetically coupled to a drive device (15) and is moved thereby.

39. The method as claimed in claim 38, further comprising at least one of a) driving at least one of the knife blade (5) or the counter element (6) by a motor, or b) mechanically coupling at least one of the knife blade (5) or the counter element (6) to an actuator that is manually actuatable from outside.

40. The method as claimed in claim 38, wherein the counter element (6) comprises at least one of a roller, a rectilinear running surface (7), or a scissor blade.

41. The method as claimed in claim 38, further comprising holding the bag (2) below the cut (13) such that the opening (14) remains closed after the cut (13) has been made.

42. The method as claimed in claim 38, wherein a knife slide (30) for the knife blade (5) is magnetically coupled to the drive device (15) and is moved thereby.

43. A method for discharging a container (3) from a bag (2), the method comprising:
cutting open the bag (2) with at least one cut (13) to form an opening (14);
discharging the container (3) via the opening (14) formed by the cut (13);
holding the bag (2) from a top side (40) of the bag (2) level with the container (3) by at least one releasable holding means (21); and
sliding the container (3) via a conveying means (31) out of the bag (2) while the bag is being held, and the conveying means (31) sliding the container (3) onto a container receptacle (34) of a transport unit (33) at least until a center of gravity of the container (3) lies above the container receptacle (34).

44. The method as claimed in claim 43, wherein the transport unit (33) is at least one of magnetically coupled to a stationary coil arrangement (35) or moved suspended in an electromagnetic field.

45. The method as claimed in claim 43, further comprising, at least during the sliding of the container (3), directing a fluid flow (25) against the inserted bag (2) at least one of against a sliding direction (A) or against a discharge side (43).

46. The method as claimed in claim 32, wherein the method is at least one of carried out in a protected room (27) or with the bag (2) having sterile contents.

47. An unpacking device (26), comprising: the cutting device (1) located within a protected clean room (27).
